(19) United States
(12) Patent Application Publication
(10) Pub. No.: US 2018/0096308 A1
(43) Pub. Date: Apr. 5, 2018

(54) ACTIONABLE WORKFORCE OPTIMIZATION PLATFORM

(71) Applicants: Adam Roseman, Atlanta, GA (US); Michael R. Loeb, New York, NY (US)

(72) Inventors: Adam Roseman, Atlanta, GA (US); Michael R. Loeb, New York, NY (US)

(21) Appl. No.: 15/718,416

(22) Filed: Sep. 28, 2017

Related U.S. Application Data
(60) Provisional application No. 62/500,050, filed on May 2, 2017.
(60) Provisional application No. 62/402,174, filed on Sep. 30, 2016.

(51) Int. Cl. G06Q 10/10

(52) U.S. Cl. CPC G06Q 10/1053; G06Q 10/1093

(57) ABSTRACT

Provided are a system and method for determining at least one optimal shared economy candidate for a user. In one example, the method includes receiving, via a web browser, user attributes comprising two or more of property assets of the user, adherency information, trust information, motivation information, and psychological information, of a user, receiving, via the web browser, a user schedule comprising periods of availability of the user with respect to a predetermined period of time, executing an actionable workforce optimization engine which receives, as input, a plurality of shared economy candidates, the user attributes, and the user schedule, and determines an optimal shared economy candidate for the user from among the plurality of shared economy candidates based on the inputs, and outputting information about the determined optimal shared economy candidate for display on a display device.

### CROSS-REFERENCE TO RELATED APPLICATIONS

This application claims the benefit under 35 USC § 119(e) of US Provisional Patent Application No. 62/402,174, filed on Sep. 30, 2016, and the benefit of U.S. Provisional Patent Application No. 62/500,050, filed on May 2, 2017, the entire disclosures of which are hereby incorporated by reference and for all purposes.

### BACKGROUND

A shared economy also referred to as a gig economy is an environment in which temporary positions are common and organizations contract with independent workers for short-term engagements. The trend towards a gig economy is already underway. A recent study predicted that by 2020, approximately forty percent (40%) of American workers will have some form of earnings as an independent contractor. There are significant forces behind the rise in short-term temporary jobs. For one thing, in the digital age, the workforce is increasingly mobile and work can increasingly be done from anywhere. As a result, in many cases a job performance and its location are decoupled. Many companies and organizations that are established as a gig economy rely on social networking and Internet-based sites to attract and identify new workers, and also to keep current workers informed of various company-related information. Furthermore, freelancers can select among temporary jobs and projects around the world, while employers can select the best individuals for specific projects from a larger pool than that available in any given area.

Through shared economies, people now have significantly more opportunities with which to earn income or additional income, for example, in order to pay off debts, save for money for a home, save for college tuition, and the like. For example, a recent survey estimated that the average household in the United States has approximately $130,000 in debt with roughly $15,000 of the debt being carried by credit card accounts. It's easy to say that debtors should simply pay off their balances and free themselves of the financial and emotional burdens that come from living in debt. But it's not that simple. Debt is not just a result of irresponsible spending. A significant amount of debts go unpaid as a result of outside factors such as lost jobs, changes in family situation, unexpected expenses, death, and many other reasons. The result is that many debts go unpaid due to unforeseen consequences.

However, many debtors and other persons able to provide services and assets to shared economies are not familiar with shared economy registration processes or may be simply unaware that shared economies exist. Accordingly, what is needed is a way to provide debtors and other people with a platform that can facilitate potential income earning opportunities.

### SUMMARY

In one general aspect, provided is a computer-implemented that includes receiving, via a web browser, user attributes comprising two or more of property assets of the user, adherency information, trust information, motivation information, and psychological information, of a user, receiving, via the web browser, a user schedule comprising periods of availability of the user with respect to a predetermined period of time, executing an actionable workforce optimization engine which receives, as input, a plurality of shared economy candidates, the user attributes, and the user schedule, and determines an optimal shared economy candidate for the user from among the plurality of shared economy candidates based on the inputs, and outputting information about the determined optimal shared economy candidate for display on a display device.

In another general aspect, provided is computing system that includes a network interface configure to receive, via a web browser, user attributes comprising two or more of property assets of the user, adherency information, trust information, motivation information, and psychological information, of a user, and receive, via the web browser, a user schedule comprising periods of availability of the user with respect to a predetermined period of time, a processor configured execute an actionable workforce optimization engine which receives, as input, a plurality of shared economy candidates, the user attributes, and the user schedule, and determines an optimal shared economy candidate for the user from among the plurality of shared economy candidates based on the inputs, and an output configured to output information about the determined optimal shared economy candidate for display on a display device.

Other features and aspects may be apparent from the following detailed description, the drawings, and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a configuration of a workforce optimization system in accordance with an example embodiment.

FIG. 2 is a diagram illustrating an optimization process for determining a best-fit for a user in accordance with an example embodiment.

FIG. 3 is a diagram illustrating an optimization process for optimizing a user schedule for repaying an existing debt in accordance with an example embodiment.

FIG. 4 is a diagram illustrating an actionable workforce optimization method in accordance with an example embodiment.

FIG. 5 is a diagram illustrating a computing system for performing workforce optimization in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth to explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments are directed to a workforce optimization engine that provides users (or other entities such as banks and financial institutions standing in the shoes of the user) with optimal shared economy opportunities (i.e., gig economy) for a user to participate in. The workforce optimization engine may receive information about the user as inputs and determine a best-fit for the user. For example, the workforce optimization engine may receive user attributes and property information, as well as a user schedule/availability, and receive criteria about a plurality of shared economy candidates (e.g., temporary labor, ride service, home rental service, etc.). Based on these inputs, the workforce optimization engine may determine one or more optimal shared economy candidates for the respective user based on one or more models or algorithms which are designed based on machine learning of historical users.

For example, a user may have any number of valuable assets such as real property, automobiles, mobile phones, skill sets, education, and the like, which can be used to generate revenue in some way. In addition, the user may have other attributes about such as trustworthiness, psychological factors, adherency traits, motivational goals, and the like, which make the user of interest for temporary hire by shared economy candidates. The workforce optimization engine may receive the user attributes, as well as a user availability or schedule (e.g., time off from a primary job, etc.) and also receive the criteria from the different shared economy candidates, and identify at least one optimal opportunity for the user based on all the received inputs. Furthermore, in some embodiments, the platform may glean user attributes from a social networking account of the user without requiring the user to enter this information through a site.

The optimization engine receives inputs such as pre-existing assets and attributes about the user, and matches the user with various gig economy jobs, tasks, skills, etc., which they can perform utilizing their pre-existing assets, background, skills, and the like. Furthermore, the optimization engine can find a “best fit” for the user from among the plurality of possible shared economy candidates based on user attributes, user availability, and criteria of the different shared economies. In addition, the optimization engine can also find one or more “next-best fits” for the user in order to fill out a user's schedule/availability to provide the user with a plan to most efficiently make money and/or pay off a debt.

The optimization engine may match the user to a revenue generating opportunity provided by a shared economy or a gig economy which the user is most likely to perform well at and satisfy requirements of the shared economy based on machine learning models. For example, some of the opportunities for which a debtor can be matched to include driving for a car service (e.g., a taxi, limo, Uber, Lyft, etc.), renting out real property (e.g., Airbnb, booking.com, etc.), generating and returning crowdsourcing data (e.g., using a mobile device or home computer), working as a delivery driver, performing telemarketing services at a call center, manual and temporary labor, and the like. In some examples, available opportunities may be provided to the user based on surge pricing as well as other criteria based on the user's specific abilities and resources. These companies and organizations can feedback information to the platform about users that perform well, and the machine learning models can be generated/adapted based on this information.

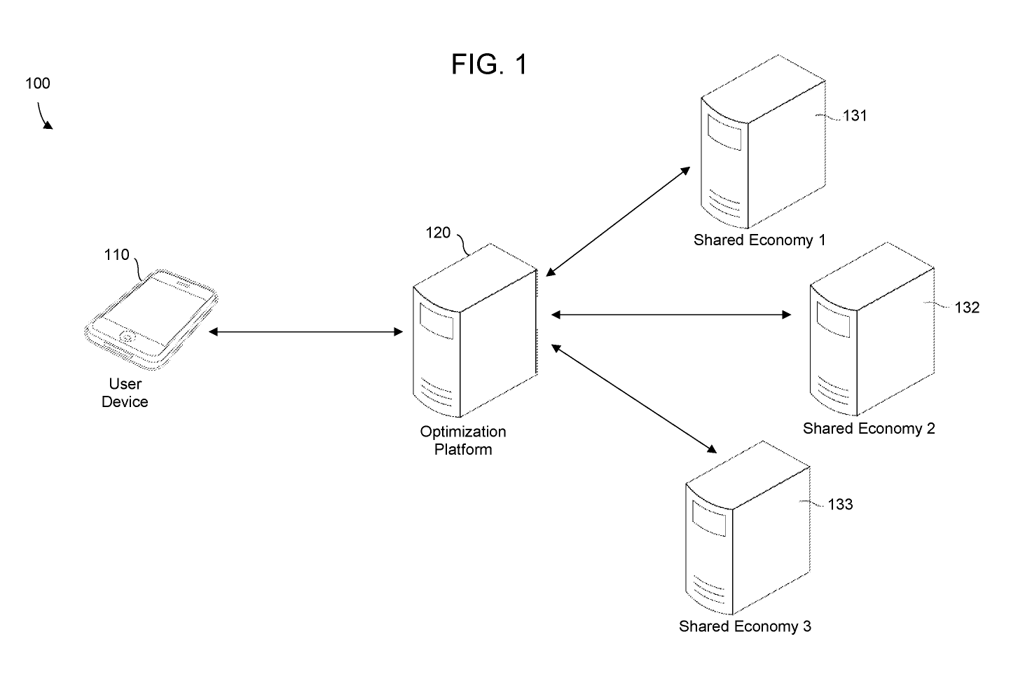

FIG. 1 illustrates a configuration of a workforce optimization system 100 in accordance with an example embodiment. Referring to FIG. 1, the system 100 includes a user device 110, an optimization platform 120 which may be a web server or cloud computing system, and a plurality of shared economy candidates 131, 132, and 133. The shared economy candidates may be organizations looking to hire temporary workers, laborers, drivers, crowdsourcing users, etc. The devices included in the system 100 may be connected to each other via a network such as the Internet, a private network, a combination thereof, or the like. The network may be wired, wireless, or a combination thereof. In this example, the user device 110 may correspond to a device operated by a user who registers with an optimization site hosted by the optimization platform 120. The user device 110 may include a mobile device, a computer, a laptop, a notebook computer, a tablet, a kiosk, and the like. The registration process may involve a user providing information such as answering psychological information, personal information, uploading availability, goal-setting, and the like. The information may be input through fields of a website hosted by the optimization platform 120. As another example, the user may provide information about themselves by uploading a file or document with personal/psychological information, a resume, a schedule/availability, and the like.

According to various embodiments, the optimization platform 120 may auto-detect electronic records of the user via from one or more sources through the Internet. For example, the user may connect the user device 110 to the optimization platform 120 by entering a web address of a corresponding website offered by the matching server 120 in a web browser installed on the user device 110. In response to a user selection, the optimization platform 120 may auto detect electronic records of the user with or without additional information provided by the debtor. For example, the electronic records may include public records such as court documents, marital documents, property related documents (deeds), trusts, social media information, cookies database information, automotive sale records, driving records, and the like. In addition, the optimization platform 120 may glean information about the user such as trustworthiness, motivations, and the like, from a social networking account of the user.

In some embodiments, the optimization platform 120 may be an arm of a bank or lending institution, and as a result, may also have access to various private documents such as the banks' information, debtor credit history (e.g., FICO score), employment history, wages, and the like. In this example, the optimization platform 120 is enhanced by dealing with the bank's arm of collection, thereby getting access to the same information that the bank has access to, allowing the optimization platform 120 to better understand the abilities of the user. Accordingly, the optimization platform 120 may access or perform a creditworthiness check on the debtor as part of a function of operating on the platform. In addition, the electronic records may include property records indicating that the debtor owns a home, an automobile, and the like. As another example, the electronic records may include employment information of the debtor, education, job history, and the like, that are extracted from the Internet such as from a LinkedIn account, and the like.

According to various embodiments, the optimization platform 120 may determine one or more of the shared economy candidates 131-133 are an optimal fit for the user based on the pre-existing assets of the user, user attributes, user schedule, criteria of the shared economy candidates, and the like. The optimization platform 120 may execute one or more algorithms that are based on machine learning from historical user data associated with the shared economy candidates 131-133. As will be appreciated, a user may not even be aware of all shared economy opportunities available, nor the opportunities at which they will perform well. The example embodiments can identify and determine an optimal shared economy opportunity for the user. Furthermore, if the user is trying to earn a specific amount of money over a predetermined period of time, the optimization engine executed by the optimization platform 120 can mix-and-match multiple shared economy candidates into a user's schedule enabling the user to earn money as fast as possible through as many shared economic opportunities available to the user and which the user will be a good fit for.

For example, the optimization platform 120 may provide the user with a plurality of shared economy incoming earning opportunities such as renting out their house or apartment on Airbnb, booking.com, and the like, using their automobile to generate revenue by driving for a car service (Uber, Lyft, etc.), generating crowdsourcing data using a mobile device or a computer, and the like, providing a listing of a job opportunity based on the educational achievement, and the like, unskilled-labor and other temporary labor opportunities, and the like. In some cases, the optimization platform 120 may analyze the debtor's driving record to determine if the user can qualify for a position as an Uber driver. Furthermore, the optimization platform 120 may take it a step further and submit an application on behalf of the user to one or more of the shared economy candidates 131-133.

After identifying the possible shared economy opportunities for the user, the optimization platform 120 may generate a unified interface (e.g., via the website) in which each of the plurality of shared economy candidates available to the user are simultaneously represented with their own respect link, icon, or the like, and which are capable of being chosen by the user through the user device 110. For example, the interface may be output from the optimization platform 120 and displayed through a web browser of the user device 110. Furthermore, the user of the user device 110 may select one of the shared economy opportunities (e.g., a corresponding icon or link) and the selection may be transmitted to the optimization platform 120. In response to receiving the selection of the shared economy opportunity, the optimization platform 120 may transfer a connection of the user device 110 to a website associated with the selected shared economy candidate. As another example, the optimization platform 120 may submit an application to the shared economy candidate on behalf of the user.

The unified website provided by the matching server 120 may be implemented as part of an on-demand workforce marketplace where debtors/users and other entities interested in their labor services can interact virtually. Chat boards and job postings may be listed on the website and users may virtually communicate with one another as if in a virtual world. The system 100 described herein provides a virtual environment that enables an on-demand work force of unskilled and skilled labor that is consistently available from a pool of users. As a result, entities needing labor may be attracted to the marketplace only at times of need rather than employ laborers full-time. Furthermore, opportunities may be provided based on needs of particular employers as well as skills associated with particular debtors which are provided to the optimization platform 120. Users may also be matched to shared economy opportunities at different times based on optimal surge pricing which can change in real-time thereby providing users with their best opportunities to earn money based on what is most needed at a present time. In addition, gamification may be provided around initiating a habit loop for usage of the platform, utilizing variable incentives that utilize varying external triggers to create internal triggers with respect to debtors and the available opportunities.

In addition to matching debtors, the example embodiments may also perform matching for all independent laborers (not just debtors). The application of this technology can carry forward well beyond debtors. The example embodiments may optimize earnings of independent laborers by matching them based on a variety of first-party and third-party data combined with first-party psychographic/interest data. The on-demand labor may include opportunities to perform landscaping or yardwork, construction, trash collection, recycling collection, chauffer or limo service such as UBER, and the like. As another example, distributed call centers may be located throughout certain areas where debtor/users can perform telemarketing or other similar services as part of their debt repayment. In various aspects, the optimization platform 120 may identify dynamic opportunities that change over time for the user and consistently change the opportunities provided to the user through the website. The new and dynamic opportunities may be communicated to the optimization platform 120 through an application programming interface (API) of the shared economy. The opportunities may be communicated to an API of the unified website provided by the optimization platform 120. Accordingly, shared economy opportunities can be presented to a user (e.g., debtor, consumer, etc.) in real-time in order to always maximize and optimize earning potential for that user.

For example, the optimization platform 120 may identify leading indicators (e.g., when analyzing credit files of a debt portfolio) that provide alerts or indications of those debtors most suited to be an actionable target. Furthermore, one or more machine learning algorithms for dynamic on-demand optimized workforce placement may be performed to crunch various data inputs received by the optimization platform 120, including those provided through credit files, data appended from a number and interest/psychographic data that may be acquired from a user during the registration process. Furthermore, in some embodiments, the system 100 may categorize a debtor into a particular profile or debtor archetype based on various information about the debtor (e.g., personal, financial, and the like. Based on these categories, the debtor may be matched with different options for paying down their debt or be provided with different plans, hourly pay, availability, and the like.

Furthermore, the optimization platform 120 may match users with real-time supplementary or primary income opportunities that provide for best fit and highest income earning levels. The platform 120 may provide the user with customized goal setting features (e.g., reduce debts, save for retirement, vacation savings, wedding, house down payment, etc.) while providing the user with a loop of possible labor opportunities. The optimization platform 120 can optimize income earning possibilities for unskilled and semi-skilled laborers, or for trained professionals seeking additional income. The optimization platform 120 executes one or more machine learning algorithms that can identify leading indicators of a user that is willing yet unable or unaware of shared economy opportunities that are available to them and that would be a good fit for them. The optimization platform 120 can match users based on various interests, psychographic data, machine learning based on historical matching of users, target criteria of shared economy candidates, and the like, and also continuously learn from how the user does when matched to shared economy opportunities to better fine tune future matches.

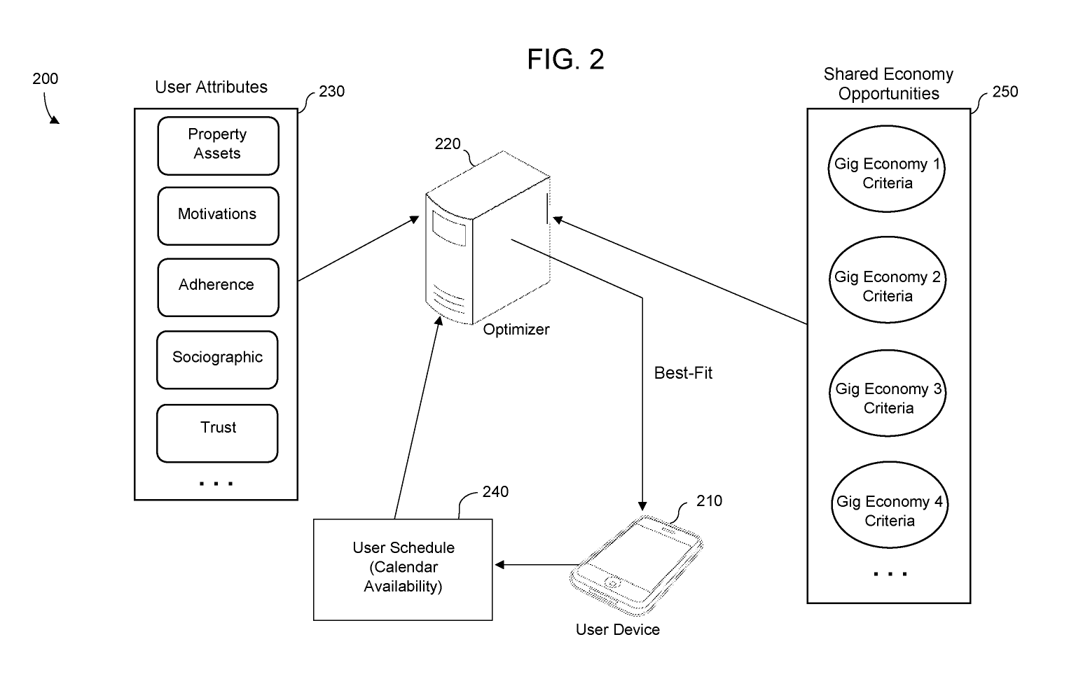

FIG. 2 illustrates an optimization process 200 for determining a best-fit for a user in accordance with an example embodiment. For example, the optimization process may be performed by the optimization platform 120 in FIG. 1, or another computing system. Referring to FIG. 2, a plurality of user attributes 230 and a user schedule 240 are transmitted to or otherwise provided to the optimizer 220. The optimizer 220 also receives information about a plurality of shared economy opportunities and criteria associated with each shared economy candidate 250. The optimizer 220 may execute an actionable workforce optimization engine that receives all the inputs (e.g., user attributes 230, user schedule 240, and shared economy criteria 250), and determines one or more optimal shared economy candidates for the user based on one or more machine learning algorithms which are executed by the optimizer 220 and included within the optimization engine. Here, information about the one or more optimal shared economy candidates (i.e., best-fit) are provided to the user device 210 for display on a screen thereof. Furthermore, the optimizer 220 may continually receive information from the user, the user schedule, and from the shared economy opportunities, and update or modify dynamically the best-fit shared economy candidates for the user based on factors such as pricing, need, availability of the user, and the like.

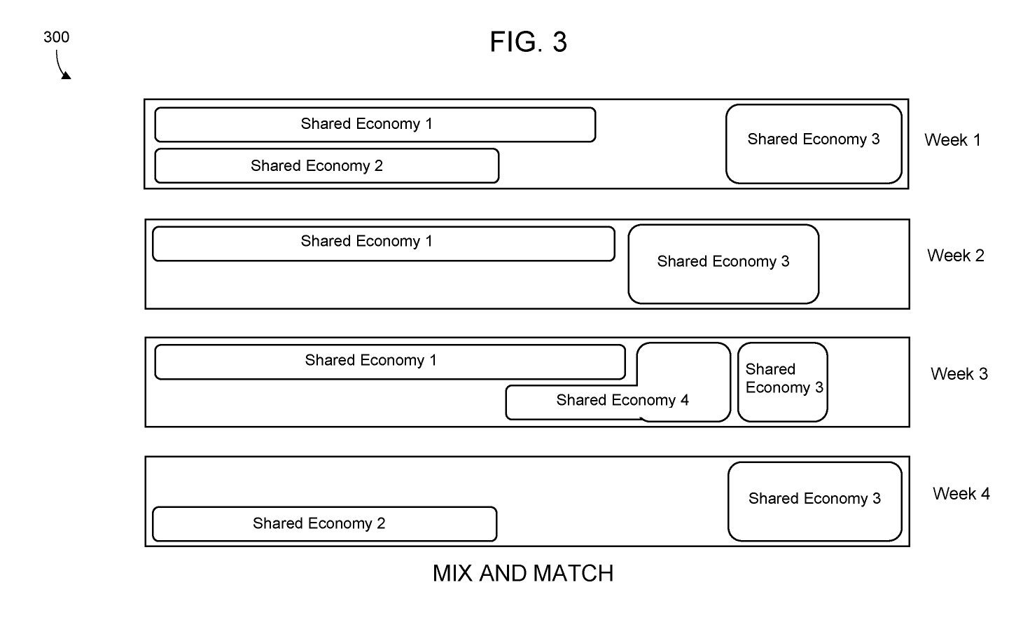

FIG. 3 illustrates an optimization process 300 for generating an optimal work plan for a user in accordance with an example embodiment. For example, the optimization process 300 may be performed by the optimization platform 120 shown in FIG. 1. Here, the optimization process 300 mixes and matches a plurality of shared economy candidates within a user availability schedule to generate an optimum income earning plan for the user. The mixing and matching can be performed by one or more algorithms included in the actionable workforce optimization engine and can be based on earning opportunity of each shared economy task, times at which the shared economy needs employees, schedule of the user, and user attributes. Accordingly, the optimizer can generate a schedule in which a plurality of shared economy tasks/jobs are provided or otherwise suggested to the user. In FIG. 3, the schedule is broken down into weeks of time, however, it should be appreciated that this is merely for purposes of example. As another example, the user may receive a message or an email each day providing the best opportunity available for that user on that day, or the user may receive an updated opportunity dynamically provided during a previously scheduled day, and the like.

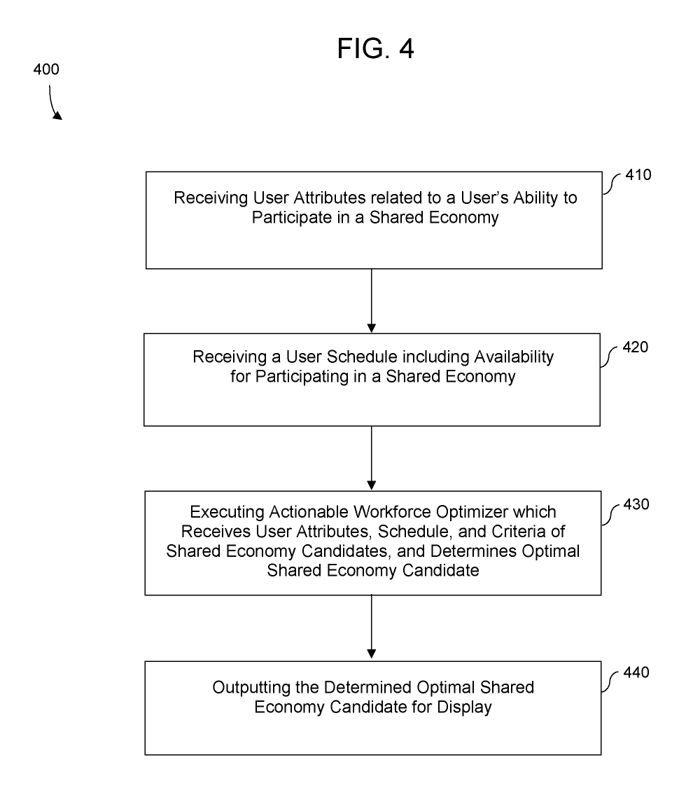

FIG. 4 illustrates an actionable workforce optimization method 400 in accordance with an example embodiment. For example, the method 400 may be performed by a computing device having a processor such as a web server, a cloud platform, or other computing device, hosting a web site or mobile application that manages the workforce optimization platform. Referring to FIG. 4, in 410, the method includes receiving, via a web browser, user attributes. Here, the web browser may be displaying a web page associated with the optimization platform/site. The user attributes may be received from a file upload, a user input through one or more fields displayed via the web browser, and the like. The user attributes may include one or more of personal property assets of the user (e.g., automobile information, real estate information, phone, computer, etc.), adherency information, trust information, motivation information, psychological information, and the like, of the user. The adherency information may indicate a likelihood of the user to follow a schedule at a respective shared economy opportunity. The trust information may indicate a level of trustworthiness of the user and the ability of the user to maintain employment. The motivation information may include goals such as debt reduction, retirement, saving for a home, and the like

In some embodiments, the user attributes such as motivation, adherency, trust, psychological information, and the like, may be determined by the computing system by automatically extracting information about the user from a social networking page, or the like, of the user. As another example, the user attributes such as the psychological information may include psychological traits of the user which are determined from a test provided to the user when they register with the workforce optimization platform/site. The motivation information may include one or more motivating factors of the user which have been identified from any number of sources including cookies, user input, social networking, and the like.

In 420, the method includes receiving, via the web browser, a user schedule including periods of availability of the user with respect to a predetermined period of time such as a week of time, a month of time, a day, or the like. The availability may be designed around a user's primary job or other tasks which occupy a majority of the user's time. In other words, the optimization platform may provide the user with a second source or a temporary source of income (e.g., a late shift). The schedule may be a document, file, spreadsheet, or other data source that can be uploaded through the web site. The availability may have different granularities. For example, the user may identify weeks, days, hours, and the like, that the user is available with particular specificity. The workforce optimization engine can be configured such that it can identify the most optimal shared economy candidate for the user based on different levels of granularity for time.

In 430, the method includes executing an actionable workforce optimization engine which receives, as input, a plurality of shared economy candidates (and criteria thereof), the user attributes, and the user schedule. In response, the workforce optimization engine may determine an optimal shared economy candidate for the user from among the plurality of shared economy candidates based on the received inputs. In 440, the method further includes outputting information about the determined optimal shared economy candidate for display on a display device. According to various embodiments, the workforce optimization engine may include one or more machine learning models that are designed based on similar historical users (e.g., similar attributes, assets, availability) with respect to a current user which have been designed based on historical data of previous users to the system. The models may include contributions from each of user attributes (e.g., personality traits, property assets, trust information, adherency information, etc.), user availability/schedule, and criteria of each of the shared economy candidates, from historical users and candidates that they were previously matched with the shared economy candidates. Furthermore, the optimization platform may receive feedback from the shared economy candidates which a user does not have access to. The feedback may indicate specific user criteria that has been found to work well with the particular shared economy.

The machine learning models/algorithms executed by the actionable workforce optimization engine may be used to identify one or a predetermined number of shared economy jobs/tasks within a given schedule/availability which are optimal for a respective user, by comparing the user attributes, the user schedule, and shared economy criteria against group of possible shared economy opportunities (there could be dozens). The criteria of a shared economy may include traits that the shared economy is seeking from temporary contractors/employees. Also, the workforce optimization engine may be configured to identify a best-fit for the respective user based on the user's skills and/or a fastest schedule for the user to pay off a debt. Here, the optimizer may mix-and-match different shared economy candidates at different times/dates within the user's availability based on the user's schedule and based on a best-fit for the user, and generate a work plan for the user to pay off the debt in the fastest and most optimal amount of time.

Accordingly, the workforce optimization engine can provide users with a wealth of information and opportunities through a single click of a button after the user has registered with the platform. In contrast, without the platform, a user would have to manually identify opportunities and figure out the availability and criteria of those opportunities, manually. Furthermore, a user may not be aware of all possible opportunities and of the criteria that each shared economy candidate is looking for or that is successful with the shared economy. This information may be fed to the platform from the shared economies and may not be accessible to the user, on their own. Furthermore, the workforce optimization engine may perform functions which a user is not capable of performing on their own such as finding the optimal shared economy candidate (opportunity) based on historical models of previous users interacting with shared economies. This historical data may be used to generate machine learning models that can be applied to a current user in order to predict the most optimal shared economy for the user.

The workforce optimization engine may be a software program or algorithm that can be executed by a processor of a computing device. When executed, the actionable workforce optimization engine may extract criteria of each of the plurality of shared economy candidates, and determine the optimal shared economy candidate from among the plurality based on the extracted criteria of each of the plurality of shared economy candidates and the user attributes and availability. For example, the actionable workforce optimization engine may include one or more machine learning models which can predict how well a user will perform at a particular shared economy task based on historical data of other users or the same user. The extracted criteria of each shared economy candidate may include one or more of property asset requirements, adherency requirements, trust requirements, motivational requirements, and psychological requirements. Prior to the optimization engine identifying the optimal shared economy candidate, the platform may extract social network information about the user from a social networking account associated with the user, and determine one or more of the trust information, the adherency information, and the motivation information, for the user, based on the extracted social networking information.

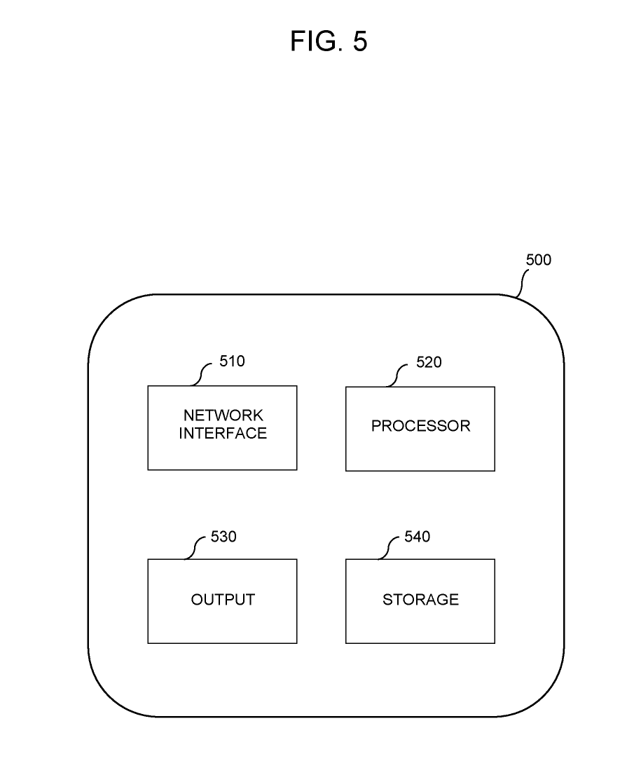

FIG. 5 illustrates a computing system 500 for performing workforce optimization in accordance with an example embodiment. For example, the computing system 500 may be a web server, a cloud computing device, a user device, or another device. Also, the computing system 500 may perform the method of FIG. 4. Referring to FIG. 5, the computing system 500 includes a network interface 510, a processor 520, an output 530, and a storage device 540. Although not shown in FIG. 5, the computing system 500 may include other components such as a display, an input unit, a receiver/transmitter, and the like. The network interface 510 may transmit and receive data over a network such as the Internet, a private network, a public network, and the like. The network interface 510 may be a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or it may be reconfigurable. The output 530 may output data to an embedded display of the device 500, an externally connected display, a cloud, another device, and the like. The storage device 540 is not limited to any particular storage device and may include any known memory device such as RAM, ROM, hard disk, and the like.

According to various embodiments, the network interface 510 may receive, via a web browser, user attributes from a user of a workforce optimization platform/site. Here, the user attributes may include one or more of property assets of the user, adherency information, trust information, motivation information, and psychological information. Furthermore, the network interface 510 may receive, via the web browser, a user schedule that includes periods of availability of the user with respect to a predetermined period of time. The user may provide the availability at different levels of granularity. The network interface 510 may receive and/or the storage device 540 may store criteria of a plurality of shared economy tasks. The criteria may be fed back from shared economy candidates and provide data on what type of users are (and what user attributes) succeed and fail at the shared economy tasks. The processor 520 may execute an actionable workforce optimization engine which receives, as input, the plurality of shared economy candidates, the user attributes, and the user schedule, and determines an optimal shared economy candidate for the user from among the plurality of shared economy candidates based on the inputs. In addition, the output 530 may output information about the determined optimal shared economy candidate for display on a display device such as an embedded display or a display of another device connected to the computing system 500 via a network such as the Internet.

According to various embodiments, when executed by the processor 520, the actionable workforce optimization engine may determine a plurality of optimal shared economy candidates and mix-and-match times and dates for performing each of the plurality of optimal shared candidates within availability of the user schedule. For example, the mixing and matching may be performed to determine and provide the user with a plan of a shortest amount of time to payoff a debt associated with the user. In this example, the actionable workforce optimization engine may determine multiple shared economy opportunities that are a best-fit for the user, and combine the opportunities within an availability of the user's schedule. For example, even though the user is available, a particular shared economy opportunity might not be available, therefore, the optimization engine can identify a next-best shared economy opportunity which is a good-fit for the user and suggest the user to perform the next-best opportunity.

The system provided herein has additional features and implementations. In some embodiments, users of the system who are hourly/independent contractors may earn paid time-off “PTO.” For example, the system may enable workers to earn PTO days based on a required numbers of hours worked. In some embodiments, the work may be spread across multiple labor platforms but be consolidated for a combined or aggregate PTO determination. In some embodiments, the platform may reserve affiliate fees received in order to fund this PTO for users as a user acquisition and retention tool.

In some embodiments, in the matching technology, guidance may be provided by the platform to users based on the user's earnings and profile/fit) which can give the user insight on how to move up the value chain over time. For example, suppose a user enjoys working with kids and is very caring but they don't qualify for Care.com work because they have not received a CPR qualification. The platform can automatically suggest Care.com as a possible work option along with a suggestion to achieve this qualification to enable the user to qualify based on the user's profile being interested in working with kids, and the user's specific deficiency of a lack of CPR training. In addition, certification (badges) based on qualifications levels/categories may be displayed within the user's account or dashboard. As another example, financial goals tied to income-generating suggestions may be provided by the platform to the user, such as goals to save for retirement, build a safety net, save for a family vacation, reduce debt, etc.

The platform may perform the function of a centralized hub for independent labor earnings analysis, by collecting earnings reports (e.g., daily, weekly, etc.) from each of the users and forecast earnings by an attribute such as zip code, labor platform, time of day, day of week, etc. and provide this information to users and shared economy employers. Users may also have the ability to increase or otherwise improve their credit in a case where a lending partner agrees to guarantee an increase in credit limit for borrowers if they work a certain number of hours for a defined number of months. The centralized independent labor earnings hub (based on receipt of the earnings reports) may also provide a tool to support lending models against non W-2 income, given that banks today focus on lending against verifiable W-2 income and may also issue credit products off of independent labor/non W-2 income based on our data hub. The platform may also provide full-time job benefits/tools in one place to 1099 workers, the uniqueness is all in one place (e.g., healthcare exchange, 1099 tax module, PTO, etc.) The platform may also provide a work calendar (e.g., weekly, monthly, etc.) for independent laborers to populate through the platform based on supply/demand flux of labor platforms in their area during the week.

In some embodiments, the platform also enables load balancing, and in particular, a calendar integration process for the user that helps the user to predict and reserve their flexible/independent labor opportunities to fill their calendar and optimize their days with a combination of pre-booked opportunities and opportunities that are on-demand to fill open times (e.g., ridesharing and delivery), which we also tend to block off for peak times when best rates and utilization will be achieved.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described regarding specific examples, it should be understood that various changes, substitutions, and alterations apparent to those skilled in the art can be made to the disclosed embodiments without departing from the spirit and scope of the disclosure as set forth in the appended claims.

What is claimed is:

1. A computer-implemented method comprising:
receiving, via a web browser, user attributes comprising two or more of property assets of the user, adherency information, trust information, motivation information, and psychological information, of a user;
receiving, via the web browser, a user schedule comprising periods of availability of the user with respect to a predetermined period of time;
executing an actionable workforce optimization engine which receives, as input, a plurality of shared economy candidates, the user attributes, and the user schedule, and determines an optimal shared economy candidate for the user from among the plurality of shared economy candidates based on the inputs; and
outputting information about the determined optimal shared economy candidate for display on a display device.

2. The computer-implemented method of claim 1, wherein, when executed, the actionable workforce optimization engine extracts criteria of each of the plurality of shared economy candidates, and determines the optimal shared economy candidate from among the plurality based on the extracted criteria of each of the plurality of shared economy candidates with respect to the user attributes and the user schedule.

3. The computer-implemented method of claim 2, wherein the extracted criteria comprises two or more of property asset requirements, adherency requirements, trust requirements, motivational requirements, and psychological requirements.

4. The computer-implemented method of claim 1, wherein the method further comprises extracting social network information about the user from a social networking account associated with the user, and determining one or more of the trust information and the motivation information based on the extracted social networking information.

5. The computer-implemented method of claim 1, wherein, when executed, the actionable workforce optimization engine determines a plurality of optimal shared economy candidates and mixes and matches times and dates for performing the plurality of optimal shared candidates within an availability of the user schedule.

6. The computer-implemented method of claim 5, wherein the mixing and matching is performed to determine a shortest amount of time to payoff a debt associated with the user.

7. The computer-implemented method of claim 1, wherein the shared economy candidates comprise one or more of a ride service, a delivery service, a temporary on-demand labor service, a home rental service, and a crowdfunding service.

8. The computer-implemented method of claim 1, wherein:
the property assets comprise one or more of a real property and an automobile;
the adherency information comprises a likelihood of the user to follow a schedule;
the trust information comprises a level of trustworthiness of the user;
the psychological information comprises psychological traits of the user; and
the motivation information comprises one or more motivating factors for the user.

9. The computer-implemented method of claim 1, wherein the actionable workforce optimization engine comprises an executable machine learning module that receives the inputs and generates at least one optimal shared economy candidate for the respective user based on one or more historical models.

10. A computing system comprising:
a network interface configure to receive, via a web browser, user attributes comprising two or more of property assets of the user, adherency information, trust information, motivation information, and psychological information, of a user, and receive, via the web browser, a user schedule comprising periods of availability of the user with respect to a predetermined period of time;
a processor configured execute an actionable workforce optimization engine which receives, as input, a plurality of shared economy candidates, the user attributes, and the user schedule, and determines an optimal shared economy candidate for the user from among the plurality of shared economy candidates based on the inputs; and
an output configured to output information about the determined optimal shared economy candidate for display on a display device.

11. The computing system of claim 10, wherein, in response to executing the actionable workforce optimization engine, the processor extracts criteria of each of the plurality of shared economy candidates, and determines the optimal shared economy candidate from among the plurality based on the extracted criteria of each of the plurality of shared economy candidates with respect to the user attributes and the user schedule.

12. The computing system of claim 11, wherein the extracted criteria comprises two or more of property asset requirements, adherency requirements, trust requirements, motivational requirements, and psychological requirements.

13. The computing system of claim 10, wherein the processor is further configured to extract social network information about the user from a social networking account associated with the user, and determine one or more of the trust information and the motivation information based on the extracted social networking information.

14. The computing system of claim 10, wherein, in response to executing the actionable workforce optimization engine, the processor determines a plurality of optimal shared economy candidates and mixes and matches times and dates for performing the plurality of optimal shared candidates within an availability of the user schedule.

15. The computing system of claim 14, wherein the processor performs the mixing and matching to determine a shortest amount of time to payoff a debt associated with the user.

16. The computing system of claim 10, wherein the shared economy candidates comprise one or more of a ride service, a delivery service, a temporary on-demand labor service, a home rental service, and a crowdfunding service.

17. The computing system of claim 10, wherein:
the property assets comprise one or more of a real property and an automobile;
the adherency information comprises a likelihood of the user to follow a schedule;
the trust information comprises a level of trustworthiness of the user;
the psychological information comprises psychological traits of the user; and
the motivation information comprises one or more motivating factors for the user.

18. The computing system of claim 10, wherein the actionable workforce optimization engine comprises an executable machine learning module that, when executed by the processor, receives the inputs and generates at least one optimal shared economy candidate for the respective user based on one or more historical models.

19. A non-transitory computer readable storage medium having program instructions which, when executed by a processor, are configured to control the processor to perform a method comprising:
receiving, via a web browser, user attributes comprising two or more of property assets of the user, adherency information, trust information, motivation information, and psychological information, of a user;
receiving, via the web browser, a user schedule comprising periods of availability of the user with respect to a predetermined period of time;
executing an actionable workforce optimization engine which receives, as input, a plurality of shared economy candidates, the user attributes, and the user schedule, and determines an optimal shared economy candidate for the user from among the plurality of shared economy candidates based on the inputs; and
outputting information about the determined optimal shared economy candidate for display on a display device.

20. The non-transitory computer readable storage medium of claim 19, wherein, when executed, the actionable workforce optimization engine extracts criteria for each of the plurality of shared economy candidates, and determines the optimal shared economy candidate from among the plurality based on the extracted criteria of each of the plurality of shared economy candidates with respect to the user attributes and the user schedule.
